(19) United States
(12) Patent Application Publication
(10) Pub. No.: US 2005/0025877 A1
(43) Pub. Date: Feb. 3, 2005

(54) Hydrolyzed vegetable protein liquid compositions

(75) Inventors: Lynn M. Cuenca, Caloocan City (PH); Christina Rowena S. Bautista, Batangas (PH); Flora H. Alvarez, Bulacan (PH); Kennie U. Dee, Quezon City (PH)

Correspondence Address: BROWN & MICHAELS, PC;400 M & T BANK BUILDING, 118 NORTH TIOGA ST, ITHACA, NY, 14850, US

(73) Assignee: NUTRI-ASIA, INC., Mandaluyong City (PH)

(21) Appl. No.: 10/887,487

(22) Filed: Jul. 8, 2004

(30) Foreign Application Priority Data
Jul. 28, 2003 (PH) 12003000324

(51) Int. Cl. A23L 1/10

(52) U.S. Cl. 426/650

(57) ABSTRACT

Good tasting hydrolyzed vegetable protein liquid seasoning compositions where the vegetable protein has been hydrolyzed with sulfuric acid. The novel compositions address the bitter taste associated with sulfuric acid-hydrolyzed vegetable proteins.

### REFERENCE TO RELATED APPLICATIONS

This application claims an invention which was disclosed in Republic of the Philippines Patent Application No. 12003000324, filed Jul. 8, 2003, entitled “HYDROLYZED VEGETABLE PROTEIN LIQUID COMPOSITIONS”. Pursuant to 35 U.S.C. § 119 (a)-(d) and (f), 35 U.S.C. § 172 and 35 U.S.C. § 365(a) and (b), the benefit of the earlier-filed foreign application is hereby claimed, and the aforementioned application is hereby incorporated herein by reference in its entirety.

### BACKGROUND OF THE INVENTION

1. Field of the Invention

The invention pertains to the field of food science. More particularly, the invention pertains to good tasting hydrolyzed vegetable protein liquid seasoning compositions where the vegetable protein has been hydrolyzed with sulfuric acid.

2. Description of Related Art

The preparation of conventional hydrolyzed vegetable proteins (HVP), most commonly hydrolyzed soybean protein, is generally carried out by acid hydrolysis with concentrated hydrochloric acid. As is known, hydrolyzing protein with hydrochloric acid results in chlorination of glycerol, derived from the residual fatty substances present in the crude protein, which produces chlorohydrins such as mono-chloropropanediols and di-chloropropanol. These chlorohydrins are suspected to be potential carcinogens based on animal tests and are therefore undesirable even though no epidemiological data exists to support their carcinogenicity in human population.

The formation of the chlorohydrins can be avoided by using sulfuric acid in place of hydrochloric acid. However, the hydrolyzed proteins produced by hydrolyzing with sulfuric acid are of inferior quality since they exhibit a bitter flavor.

The present invention relates to novel hydrolyzed vegetable protein liquid seasoning compositions using sulfuric acid-HVP having improved organoleptic quality. More specifically the invention relates to formulations using sulfuric acid-HVP in preparation of soy sauce or soy-based seasonings.

### SUMMARY OF THE INVENTION

The present invention relates to good tasting hydrolyzed vegetable protein liquid seasoning compositions where the vegetable protein has been hydrolyzed with sulfuric acid. The novel compositions address the bitter taste associated with sulfuric acid-hydrolyzed vegetable proteins.

### DETAILED DESCRIPTION OF THE INVENTION

The present invention relates to hydrolyzed vegetable protein liquid compositions comprising: i). sulfuric acid-HVP; ii). a mixture of disodium inosinate and disodium guanylate; iii). an edible organic acid; and iv). a sodium chloride concentration of not more than 13% w/w.

The vegetable protein sources include, among others, corn, rice, wheat, soy, nuts, and mixtures thereof. The preferred vegetable protein source is soybean.

The flavor enhancer is a mixture consisting of disodium 5′-inosinate and disodium 5′-guanylate, a common flavor enhancer in the industry. The mixture could also come from natural sources, such as, for example, yeast extract. The mixture contains preferably 5-95% w/w, more preferably 20-80% w/w, and most preferably 30-70% w/w disodium 5′-inosinate.

The sodium chloride concentration should not be more than 13% w/w, preferably not more than 12% w/w of the composition. This concentration is less than the lower limit of the 15-25% w/w range of the Japanese Agricultural Standard for hydrolyzed soy sauce, which presumably was set for soybean hydrolyzed with hydrochloric acid. The sodium chloride limit of this invention, in combination with the flavor enhancer disodium inosinate and disodium guanylate, and the organic acid(s) are the key components in formulating an organoleptically acceptable liquid HVP product using sulfuric acid-hydrolyzed HVP.

The hydrolyzed vegetable protein liquid composition may also contain a number of other ingredients normally used in seasonings such as monosodium glutamate, sugar, caramel, colorants, alcohol, spices, preservatives, and artificial and natural flavors.

### EXAMPLES

Preparation of Hydrochloric Acid-Hydrolyzed Soy Extract:

300 kg of soybean meal (50% protein), 450 L of water, and 250 L of 30% w/v hydrochloric acid were loaded into a reactor and the hydrolysis allowed to proceed for 6 hours at 10 psi using direct steam injection. The resulting crude hydrolyzate was neutralized with sodium hydroxide, and then filtered through a plate and frame press. The cake was washed with 450 L of water. The filtrates were combined and made up with water and sodium chloride to 7.5% w/w protein and 12% w/w sodium chloride.

Preparation of Sulfuric Acid-Hydrolyzed Soy Extract:

300 kg of soybean meal (50% protein), 450 L of water, and 250 L of 35% w/v sulfuric acid were loaded into a reactor and the hydrolysis allowed to proceed for 8 hours at 10 psi using direct steam injection. The resulting crude hydrolyzate was neutralized with sodium hydroxide, and then filtered through a plate and frame press. The cake was washed with 450 L of water. The filtrates were combined and made up with water and sodium chloride to 7.5% w/w protein and 12% w/w sodium chloride.

### Example 1

The following soy sauce formulations were prepared using the sulfuric acid-hydrolyzed soybean protein produced as described above. All percentages are expressed in w/w.

| | Example | Example | Example | Example |
|---|---|---|---|---|
| Ingredients | 1A | 1B | 1C | 1D |
| Sulfuric acid-HVP | 3.75% | 3.75% | 3.75% | 3.75% |
| Sodium Chloride | 11% | 11% | 11% | 11% |
| Lactic Acid | — | — | 0.06% | 0.06% |
| I + G* | — | 0.045% | — | 0.045% |
| Monosodium glutamate | 0.5% | 0.5% | 0.5% | 0.5% |
| Caramel | 2% | 2% | 2% | 2% |
| Colorant | 0.01% | 0.01% | 0.01% | 0.01% |
| pH | 4.5 | 4.5 | 4.4 | 4.4 |

*50/50 weight ratio of disodium inosinate to disodium guanylate

Using an expert panel of 20, blind taste comparisons were conducted for each formulation against Example 1A. Example 1B was preferred by 65% of the panelists versus Example 1A. Example 1C was preferred by 55% of the panelists versus Example 1A. Example 1D, however, was preferred by 85% of the panelists versus Example 1A, clearly showing the enhanced organoleptic quality when lactic acid is combined with a mixture of disodium inosinate and disodium guanylate.

### Example 2

The following soy sauce formulations were prepared using the sulfuric acid-hydrolyzed soybean protein produced as described above. All percentages are expressed in w/w.

| | Example | Example | Example | Example |
|---|---|---|---|---|
| Ingredients | 2A | 2B | 2C | 2D |
| Sulfuric acid-HVP | 3.75% | 3.75% | 3.75% | 3.75% |
| Sodium Chloride | 11% | 11% | 11% | 11% |
| Lactic Acid | — | — | 0.04% | 0.04% |
| Flavor Mate 950 | — | 0.1% | — | 0.1% |
| Monosodium glutamate | 0.5% | 0.5% | 0.5% | 0.5% |
| Caramel | 2% | 2% | 2% | 2% |
| Colorant | 0.01% | 0.01% | 0.01% | 0.01% |
| pH | 4.5 | 4.4 | 4.4 | 4.4 |

Flavor Mate 950 (Red Star, Milwaukee, Wis. 53202) is a highly refined bakers yeast extract that contains high levels of naturally occurring disodium inosinate and disodium guanylate.

Using an expert panel of 20, blind taste comparisons were conducted for each formulation against Example 2A. Example 2B was equally preferred as Example 2A. Example 2C was also equally preferred as Example 2A. Example 2D, however, was preferred by 70% of the panelists versus Example 2A, clearly showing the enhanced organoleptic quality when lactic acid is combined with a mixture of disodium inosinate and disodium guanylate.

### Example 3

The following soy sauce formulations were prepared using the hydrochloric acid- and sulfuric acid-hydrolyzed soybean proteins produced as described above. All percentages are expressed in w/w.

| | Example | Example | Example | Example | Example | Example |
|---|---|---|---|---|---|---|
| Ingredients | 3A | 3B | 3C | 3D | 3E | 3F |
| Hydrochloric acid-HVP | 3.75% | — | — | — | — | — |
| Sulfuric acid-HVP | — | 3.75% | 3.75% | 3.75% | 3.75% | 3.75% |
| Sodium Chloride | 15% | 11% | 11% | 11% | 13% | 15% |
| Lactic Acid | — | — | 0.04% | 0.04% | 0.04% | 0.04% |
| I + G* | 0.015% | 0.15% | — | 0.15% | 0.15% | 0.15% |
| Monosodium glutamate | 0.15% | — | — | — | — | — |
| Caramel | 2% | 2% | 2% | 2% | 2% | 2% |
| Preservative | 0.1% | 0.1% | 0.1% | 0.1% | 0.1% | 0.1% |
| Colorant | 0.01% | 0.01% | 0.01% | 0.01% | 0.01% | 0.01% |
| pH | 4.5 | 4.4 | 4.4 | 4.5 | 4.5 | 4.5 |

*50/50 weight ratio of disodium inosinate to disodium guanylate

Example 3A is a commercially available soy sauce in the Philippines using hydrochloric acid-hydrolyzed soybean protein. Using an expert panel of 20, blind taste comparisons were conducted for each formulation against Example 3A. Example 3B was only 35% preferred versus Example 3A. Example 3C was also 35% preferred versus Example 3A. Example 3D, however, was equally preferred as Example 3A, clearly showing the importance of combining lactic acid with a mixture of disodium inosinate and disodium guanylate in sulfuric acid-HVP formulations.

Taste comparisons of Examples 3D, 3E and 3F against Example 3A show the effect of increasing salt level. While Example 3D at 11% w/w salt was equally preferred as Example 3A, Example 3E at 13% w/w salt was only 40% preferred versus Example 3A, and Example 3F at 15% w/w salt was monadically unacceptable organoleptically. These examples illustrate the importance of keeping the salt level below 13% w/w when using sulfuric acid-HVP.

### Example 4

The following soy sauce formulations were prepared using the hydrochloric acid- and sulfuric acid-hydrolyzed soybean proteins produced as described above. All percentages are expressed in w/w.

| Ingredients | Example 4A | Example 4B | Example 4C |
|---|---|---|---|
| Hydrochloric acid HVP | 3.75% | — | — |
| Sulfuric acid HVP | — | 3.75% | 3.75% |
| Sodium Chloride | 15% | 11% | 15% |
| Lactic Acid | — | 0.04% | 0.04% |
| Flavor Mate 950 | — | 0.1% | 0.1% |
| I + G* | 0.015% | 0.05% | 0.05% |
| Monosodium glutamate | 0.15% | 0.4% | 0.4% |
| Caramel | 2% | 2% | 2% |
| Preservative | 0.1% | 0.1% | 0.1% |
| Colorant | 0.01% | 0.01% | 0.01% |
| pH | 4.5 | 4.4 | 4.4 |

*50/50 weight ratio of disodium inosinate to disodium guanylate

Example 4A is a commercially available soy sauce in the Philippines using hydrochloric acid-hydrolyzed soybean protein. In a blind test among 100 consumers, Example 4B was 52% preferred for odor profile, and 53% preferred for taste against Example 4A. This comparison clearly shows that sulfuric acid-HVP can be formulated according to the present invention to match the organoleptic quality of commercial available hydrochloric acid-HVP formulation.

Example 4C is the same as Example 4B except that the salt is 15% w/w instead of 11% w/w. Example 4C is monadically unacceptable organoleptically showing the importance of keeping the salt level below 13% w/w according to the present invention.

### Example 5

The following soy sauce formulations were prepared using the sulfuric acid-hydrolyzed soybean protein produced as described above. All percentages are expressed in w/w.

| | Example | Example | Example | Example |
|---|---|---|---|---|
| Ingredients | 5A | 5B | 5C | 5D |
| Sulfuric acid HVP | 3.75% | 3.75% | 3.75% | 3.75% |
| Sodium Chloride | 11% | 11% | 11% | 11% |
| Monosodium glutamate | 0.45% | 0.45% | 0.45% | 0.45% |
| I + G* | 0.045% | 0.045% | 0.045% | 0.045% |
| Acetic Acid | — | 0.04% | 0.07% | 0.10% |
| Caramel | 2% | 2% | 2% | 2% |
| Colorant | 0.01% | 0.01% | 0.01% | 0.01% |
| pH | 4.5 | 4.5 | 4.4 | 4.4 |

*50/50 weight ratio of disodium inosinate to disodium guanylate

Using an expert panel of 20, blind taste comparisons were conducted for each formulation against Example 5A. Example 5B was preferred by 55% of the panelists versus Example 5A, Example 5C was preferred by 75% of the panelists versus Example 5A, and Example 5D was preferred by 65% of the panelists versus Example 5A. The results clearly show that acetic acid, an edible organic acid, can also be used in the present invention. Further, this example illustrates that there is an optimum level of acetic acid.

More broadly, it is expected that the optimum concentration of the edible organic acid will depend on the amount of sulfuric acid-HVP, the level of disodium inosinate and disodium guanylate, the ratio of disodium inosinate to disodium guanylate, the salt concentration, and the presence of other formulation ingredients. However, this optimum concentration can be readily determined from appropriate design of experiments that are known to those ordinarily skilled in the art.

While the present invention has been described in terms of its specific embodiments, certain modifications and equivalents will be apparent to those skilled in the art and are intended to be included within the scope of the present invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A hydrolyzed vegetable protein composition in liquid form, comprising:
i) sulfuric acid-hydrolyzed vegetable protein;
ii) a mixture of disodium inosinate and disodium guanylate;
iii) an edible organic acid; and
iv) a sodium chloride concentration of not more than 13% w/w.

2. The composition according to claim 1, wherein the vegetable protein source is selected from the group consisting of soybean, corn, wheat, rice, nuts, and mixtures thereof.

3. The composition according to claim 2, wherein the vegetable protein source is soybean.

4. The composition according to claim 1, wherein the hydrolyzed vegetable protein is from about 2% w/w to about 12% w/w of the composition.

5. The composition according to claim 4, wherein the hydrolyzed vegetable protein is from about 3% w/w to about 5% w/w of the composition.

6. The composition according to claim 1, wherein the disodium inosinate is from about 5% w/w to about 95% w/w of the disodium inosinate-disodium guanylate mixture.

7. The composition according to claim 6, wherein the disodium inosinate is from about 20% w/w to about 80% w/w of the disodium inosinate-disodium guanylate mixture.

8. The composition according to claim 7, wherein the disodium inosinate is from about 30% w/w to about 70% w/w of the disodium inosinate-disodium guanylate mixture.

9. The composition according to claim 1, wherein the disodium inosinate-disodium guanylate mixture is derived from fermentation, chemical syntheses, naturally occurring sources, or combinations thereof.

10. The composition according to claim 9, wherein the naturally occurring source is yeast extract.

11. The composition according to claim 1, wherein the disodium inosinate-disodium guanylate mixture is from about 0.01% w/w to about 2% w/w of the composition.

12. The composition according to claim 11, wherein the disodium inosinate-disodium guanylate mixture is from about 0.02% w/w to about 0.6% w/w of the composition.

13. The composition according to claim 1, wherein the edible organic acid is selected from lactic acid, acetic acid, malic acid, citric acid, and combinations thereof.

14. The composition according to claim 13, wherein the edible organic acid is selected from lactic acid, acetic acid, and mixtures thereof.

15. The composition according to claim 1, wherein the edible organic acid is from about 0.01% w/w to about 0.5% w/w of the composition.

16. The composition according to claim 15, wherein the edible organic acid is from about 0.02% w/w to about 0.1% w/w of the composition.

17. The composition according to claim 1, wherein the sodium chloride is not more than 12% w/w of the composition.

18. The composition according to claim 1, which further comprises monosodium glutamate from about 0.1% w/w to about 5% w/w of the composition.

19. A soy sauce, comprising:
i) 0.5% w/w to 5% w/w sulfuric acid-hydrolyzed soybean protein;
ii) 0.01% w/w to 0.5% w/w mixture of disodium inosinate and disodium guanylate;
iii) 0.01% w/w to 0.1% w/w of an edible organic acid; and
iv) a sodium chloride concentration of not more than 12% w/w.

20. The composition according to claim 19, wherein the edible organic acid is selected from lactic acid, acetic acid, malic acid, citric acid, and combinations thereof.

21. The composition according to claim 20, wherein the edible organic acid is selected from lactic acid, acetic acid, and mixtures thereof.

22. The composition according to claim 19, which further comprises monosodium glutamate from about 0.1% w/w to about 1% w/w of the composition.
